(19) United States
(12) Patent Application Publication
(10) Pub. No.: US 2025/0188762 A1
(43) Pub. Date: Jun. 12, 2025

(54) PARKING ROBOT AND METHOD OF OPERATING THE SAME

(71) Applicant: HL MANDO CORPORATION, Gyeonggi-do (KR)

(72) Inventors: Jeongjae PARK, Gyeonggi-do (KR); Dongseon KIM, Gyeonggi-do (KR); Joonkyu SONG, Gyeonggi-do (KR); Seongho CHOI, Gyeonggi-do (KR)

(21) Appl. No.: 18/972,565

(22) Filed: Dec. 6, 2024

(30) Foreign Application Priority Data
Dec. 7, 2023 (KR) 10-2023-0176749
Aug. 22, 2024 (KR) 10-2024-0112941

(51) Int. Cl. E04H 6/36; B60K 1/02; B60P 3/07

(52) U.S. Cl. CPC E04H 6/36; B60K 1/02; B60P 3/07

(57) ABSTRACT

Disclosed are a parking robot and a method of operating the same. A parking robot according to the present embodiment may include a first drive module including first driving wheels, a second drive module including second driving wheels and provided rearward of the first drive module, a first lifting module disposed between the first drive module and the second drive module, and a second lifting module provided at one side of the first lifting module, in which the second lifting module includes a caster unit having a caster wheel supported from a ground surface together with the first driving wheels and the second driving wheels.

### CROSS-REFERENCE TO RELATED APPLICATIONS

This application claims the priority of Korean Patent Application No. 10-2023-0176749 filed on Dec. 7, 2023, in the Korean Intellectual Property Office and Korean Patent Application No. 10-2024-0112941 filed on Aug. 22, 2024, in the Korean Intellectual Property Office, the disclosure of which is incorporated herein by reference.

### BACKGROUND

### Field

The present disclosure relates to a parking robot and a method of operating the same, and more particularly, to a parking robot and a method of operating the same, which are capable of automatically loading and moving a vehicle to a designated parking location in a parking system such as a parking tower or an underground parking facility.

### Description of the Related Art

The number of vehicles is increasing, but parking spaces are limited. Therefore, policies and technical studies are being consistently conducted to solve the shortage of parking spaces. In particular, automated parking systems are being actively developed to efficiently park a large number of vehicles at a limited location in a structure, such as a parking tower or an underground parking facility, having a plurality of parking spaces.

In general, the automatic parking system may include a pallet onto which the vehicle is loaded, and a conveyance mechanism configured to convey the pallet to a designated parking space. However, the automatic parking system needs to have the pallets for respective designated parking spaces including a designated initial space that allows the vehicle to enter or exit the automatic parking system. For this reason, there is a problem in that the amount of costs required to manufacture the system is comparatively large, and the structure is also complicated.

In order to solve this problem, recently, a parking robot has been developed and proliferated, and the parking robot is capable of entering a front wheel side and a rear wheel side through a lower space of the vehicle, raising the vehicle from a ground surface, and then conveying the vehicle to a designated parking space.

In general, the parking robot includes a lifting device configured to raise the vehicle from the ground surface or lower the vehicle, a drive device configured to move to a designated parking space in a state in which the vehicle is loaded onto the lifting device or to enter or exit a lower side of the vehicle in a state in which no vehicle is loaded, and a battery or the like configured to supply power to the lifting device or the drive device. For this reason, there is a problem in that the entire size of the parking robot is increased, which makes it difficult to manage light vehicles that occupy a comparatively small entrance space in the parking robot.

More specifically, as illustrated in FIG. 1, in case that parking robots 1 and 1′ are provided to be larger than a distance S1 between tires of a vehicle V defined in a width direction of the vehicle V or a distance S2 between tires of the vehicle defined in a longitudinal direction of the vehicle V, there is a problem in that the parking robots 1 and 1′ cannot enter a lower space of the vehicle.

Therefore, there is a need for a solution capable of reducing the size of the parking robot by optimally configuring and disposing constituent components such as the lifting device configured to raise the vehicle from the ground surface or lower the vehicle, the drive device configured to move to the designated parking space in a state in which the vehicle is loaded onto the lifting device or to enter or exit the lower side of the vehicle in a state in which no vehicle is loaded, and the battery configured to supply power to the lifting device or the drive device.

In addition, there is a need for a more reliable lifting device or drive device because it is necessary to manufacture the parking robot with a limited size and it is essential to move the parking robot to a designated parking space in a state in which a vehicle with a comparatively heavy weight is loaded.

### SUMMARY

An object to be achieved by the present embodiment is to provide a parking robot, which is capable of entering lower sides of front and rear wheel sides of a vehicle, lifting the vehicle, and moving a position of the vehicle to a designated parking space, and a method of operating the same.

Another object to be achieved by the present embodiment is to provide a parking robot and a method of operating the same, which are capable of excluding a movement passage or the like for a vehicle that is required for a parking space because of a rotation radius of the vehicle for implementing perpendicular parking, parallel parking, or the like.

Still another object to be achieved by the present embodiment is to provide a parking robot, in which main components are modularized and compactly disposed such that the parking robot may operate most vehicles including light vehicles with comparatively small lower spaces as well as large-scale or middle-scale vehicles with comparatively large lower spaces, and a method of operating the same.

Yet another object to be achieved by the present embodiment is to provide a parking robot, in which modularized components are disposed in a balanced manner such that the parking robot may be stably supported on a ground surface and smoothly travel even in a state in which a vehicle with a comparatively heavy weight is loaded, a method of operating the same.

An embodiment of the present disclosure may provide a parking robot including: a first drive module including first driving wheels; a second drive module including second driving wheels and provided rearward of the first drive module; a first lifting module disposed between the first drive module and the second drive module; and a second lifting module provided at one side of the first lifting module, in which the second lifting module includes a caster unit having a caster wheel supported from a ground surface together with the first driving wheels and the second driving wheels.

The parking robot may further include: a first control module provided forward of the second lifting module; a second control module provided rearward of the second lifting module; a battery module provided between the first lifting module and the second lifting module and provided rearward of the first drive module and the first control module; and a third control module provided between the first lifting module and the second lifting module and provided forward of the second drive module and the second control module.

The first drive module may include: a first plate having a first through-hole formed in a central portion thereof; a first ring coupled to the first plate and configured to be rotatable about a central axis of the first through-hole; a first tilting body including a first tilting shaft and fastened to the first ring; a first tilting shaft having two opposite ends at which the first driving wheels are rotatably provided, the first tilting shaft being coupled to the first tilting shaft so that any one side thereof is inclined upward or downward with respect to the first tilting shaft; and first drive motors respectively fixed to front and rear sides of the first tilting shaft by first drive motor brackets and configured to independently rotate the first driving wheels.

The second drive module may include: a second plate having a second through-hole formed in a central portion thereof; a second ring coupled to the second plate and configured to be rotatable about a central axis of the second through-hole; a second tilting body including a second tilting shaft and fastened to the second ring; a second tilting shaft having two opposite ends at which the second driving wheels are rotatably provided, the second tilting shaft being coupled to the second tilting shaft so that any one side thereof is inclined upward or downward with respect to the second tilting shaft; and second drive motors respectively fixed to front and rear sides of the second tilting shaft by second drive motor brackets and configured to independently rotate the second driving wheels.

The first plate may further include: a plurality of first guide rollers provided on a bottom surface of the first plate along a circumferential surface of the first through-hole and configured to guide a rotation of the first ring; and a first stopper groove provided on a top surface of the first plate along the circumferential surface of the first through-hole, and the first tilting body may further include a first stopper inserted into the first stopper groove and configured to restrict a rotation angle of the first ring from the first plate.

The second plate may further include: a plurality of second guide rollers provided on a bottom surface of the second plate along a circumferential surface of the second through-hole and configured to guide a rotation of the second ring; and a second stopper groove provided on a top surface of the second plate along the circumferential surface of the second through-hole, and the second tilting body may further include a second stopper inserted into the second stopper groove and configured to restrict a rotation angle of the second ring from the second plate.

The first drive module may include a first cable having one end fixed to a first cable outer bracket provided on the first plate, and the other end fixed to a first cable inner bracket provided on the first ring, the first cable being configured to restrict a rotation angle of the first ring.

The second drive module may include a second cable having one end fixed to a second cable outer bracket provided on the second plate, and the other end fixed to a second cable inner bracket provided on the second ring, the second cable being configured to restrict a rotation angle of the second ring.

The first lifting module may include: a first cover including a first front bar rotation shaft provided at a front side of the parking robot, and a first rear bar rotation shaft provided at a rear side of the parking robot; a first front bar configured to be folded toward the front side of the parking robot with respect to the first cover based on the first front bar rotation shaft or unfolded in a width direction of the parking robot; a first rear bar configured to be folded toward the rear side of the parking robot with respect to the first cover based on the first rear bar rotation shaft or unfolded in the width direction of the parking robot; and a first lifting motor configured to provide a rotational force so that the first front bar and the first rear bar are simultaneously folded or unfolded.

The second lifting module may include: a second cover including a second front bar rotation shaft provided at the front side of the parking robot, and a second rear bar rotation shaft provided at the rear side of the parking robot; a second front bar configured to be folded toward the front side of the parking robot with respect to the second cover based on the second front bar rotation shaft or unfolded in the width direction of the parking robot; a second rear bar configured to be folded toward the rear side of the parking robot with respect to the second cover based on the second rear bar rotation shaft or unfolded in the width direction of the parking robot; and a second lifting motor configured to provide a rotational force so that the second front bar and the second rear bar are simultaneously folded or unfolded.

The caster unit may include: an annular bearing configured such that an inner race rotates relative to an outer race; an annular bearing casing to which the bearing is fixedly coupled so that the outer race is supported on an inner peripheral surface thereof; a bearing upper cover coupled to the inner race and rotatably coupled to the inner peripheral surface of the bearing casing; and a bearing lower cover fastened to a lower side of the bearing upper cover and having a caster wheel fastening portion to which the caster wheel is coupled to be rotatable about a caster wheel rotation shaft, and the bearing casing may be fixed to a caster unit fastening hole provided between the second front bar rotation shaft and the second rear bar rotation shaft.

The caster wheel may protrude toward the ground surface from a top surface of the bearing upper cover through a bearing upper cover opening provided in the bearing upper cover and a bearing lower cover opening provided in the bearing lower cover.

The first front bar may include: a first front bar bracket to which the first front bar rotation shaft is coupled; and a first front worm wheel inserted and fixed into the first front bar bracket, the first rear bar may include: a first rear bar bracket to which the first rear bar rotation shaft is coupled; and a first rear worm wheel inserted and fixed into the first rear bar bracket, and the first lifting module may further include a first worm shaft having two opposite ends at which a first front worm gear, which engages with the first front worm wheel, and a first rear worm gear, which engages with the first rear worm wheel, are provided, the first worm shaft being installed on the first cover and configured to receive a rotational force from the first lifting motor.

The second front bar may include: a second front bar bracket to which the second front bar rotation shaft is coupled; and a second front worm wheel inserted and fixed into the second front bar bracket, the second rear bar may include: a second rear bar bracket to which the second rear bar rotation shaft is coupled; and a second rear worm wheel inserted and fixed into the second rear bar bracket, and the second lifting module may further include a second worm shaft having two opposite ends at which a second front worm gear, which engages with the second front worm wheel, and a second rear worm gear, which engages with the second rear worm wheel, are provided, the second worm shaft being installed on the second cover and configured to receive a rotational force from the second lifting motor.

The first lifting motor may be disposed in parallel with the first worm shaft in the width direction of the parking robot, and the second lifting motor may be disposed in parallel with the second worm shaft in the width direction of the parking robot.

The first lifting motor may include a first lifting belt provided on the second drive module and connected to a first worm shaft pulley provided at an end of the first worm shaft protruding from the first cover toward the second drive module.

The second lifting motor may include a second lifting belt provided on the second control module and connected to a second worm shaft pulley provided at an end of the second worm shaft protruding from the second cover toward the second control module.

The first front bar may include: a first front bar bent portion formed at a side of the first front bar bracket; and a plurality of first front bar rollers provided from the first front bar bracket to one end side of the first front bar.

The first rear bar may include: a first rear bar bent portion formed at a side of the first rear bar bracket; and a plurality of first rear bar rollers provided from the first rear bar bracket to one end side of the first rear bar.

The second front bar may include: a second front bar bent portion formed at a side of the second front bar bracket; and a plurality of second front bar rollers provided from the second front bar bracket to one end side of the second front bar.

The second rear bar may include: a second rear bar bent portion formed at a side of the second rear bar bracket; and a plurality of second rear bar rollers provided from the second rear bar bracket to one end side of the second rear bar.

The parking robot may further include a front lidar provided at a front side of the first drive module, a front camera provided at a front side of the first control module, a rear camera provided at a rear side of the second drive module, and a first lighting device and a second lighting device respectively provided at a rear side of the second drive module and a rear side of the second control module.

Another embodiment of the present disclosure may provide a parking robot, which enters a front wheel side or a rear wheel side of a vehicle, raises the vehicle from a ground surface, and moves the vehicle to a designated parking space, the parking robot including: a pair of first driving wheels provided at one side of a front side of the parking robot; a pair of second driving wheels provided at one side of a rear side of the parking robot; and a caster wheel provided at the other side of a central portion of the parking robot and configured to support the parking robot from a ground surface together with the first driving wheel and the second driving wheel.

The parking robot may further include: a first drive module including the first driving wheels; a second drive module including the second driving wheels; a first lifting module provided between the first drive module and the second drive module; a first control module provided at the other side of the front side of the parking robot; a second control module provided at the other side of the rear side of the parking robot; a second lifting module provided between the first control module and the second control module and installed with a caster unit including the caster wheel; a battery module provided between the first lifting module and the second lifting module and provided rearward of the first drive module and the first control module; and a third control module provided between the first lifting module and the second lifting module and provided rearward of the battery module.

The first drive module may include: a first plate having a first through-hole; a first ring coupled to the first plate and configured to be rotatable about a central axis of the first through-hole; a first tilting body including a first tilting shaft and fastened to the first ring; a first tilting shaft having two opposite ends at which the first driving wheels are rotatably coupled, the first tilting shaft being coupled to the first tilting shaft so that any one side thereof is inclined upward or downward with respect to the first tilting shaft; and first drive motors respectively fixed to front and rear sides of the first tilting shaft by first drive motor brackets and configured to independently rotate the first driving wheels.

The second drive module may include: a second plate having a second through-hole; a second ring coupled to the second plate and configured to be rotatable about a central axis of the second through-hole; a first tilting body including a second tilting shaft and fastened to the second ring; a second tilting shaft having two opposite ends at which the second driving wheels are rotatably coupled, the second tilting shaft being coupled to the second tilting shaft so that any one side thereof is inclined upward or downward with respect to the second tilting shaft; and second drive motors respectively fixed to front and rear sides of the second tilting shaft by second drive motor brackets and configured to independently rotate the second driving wheels.

The first drive module may further include a first steering sensor provided adjacent to the first through-hole and configured to detect a rotation angle of the first ring, and the second drive module may further include a second steering sensor provided adjacent to the second through-hole and configured to detect a rotation angle of the second ring.

The first lifting module may include: a first cover including a first front bar rotation shaft provided at a front side of the parking robot, and a first rear bar rotation shaft provided at a rear side of the parking robot; a first front bar configured to be folded toward the front side of the parking robot with respect to the first cover based on the first front bar rotation shaft or unfolded in a width direction of the parking robot; a first rear bar configured to be folded toward the rear side of the parking robot with respect to the first cover based on the first rear bar rotation shaft or unfolded in the width direction of the parking robot; and a first lifting motor configured to provide a rotational force so that the first front bar and the first rear bar are simultaneously folded or unfolded.

The second lifting module may include: a second cover including a second front bar rotation shaft provided at the front side of the parking robot, and a second rear bar rotation shaft provided at the rear side of the parking robot; a second front bar configured to be folded toward the front side of the parking robot with respect to the second cover based on the second front bar rotation shaft or unfolded in the width direction of the parking robot; a second rear bar configured to be folded toward the rear side of the parking robot with respect to the second cover based on the second rear bar rotation shaft or unfolded in the width direction of the parking robot; and a second lifting motor configured to provide a rotational force so that the second front bar and the second rear bar are simultaneously folded or unfolded.

The first front bar may include: a first front bar bracket to which the first front bar rotation shaft is coupled; and a first front worm wheel inserted and fixed into the first front bar bracket, the first rear bar may include: a first rear bar bracket to which the first rear bar rotation shaft is coupled; and a first rear worm wheel inserted and fixed into the first rear bar bracket, and the first lifting module may further include a first worm shaft having two opposite ends at which a first front worm gear, which engages with the first front worm wheel, and a first rear worm gear, which engages with the first rear worm wheel, are provided, the first worm shaft being installed on the first cover and configured to receive a rotational force from the first lifting motor.

The second front bar may include: a second front bar bracket to which the second front bar rotation shaft is coupled; and a second front worm wheel inserted and fixed into the second front bar bracket, the second rear bar may include: a second rear bar bracket to which the second rear bar rotation shaft is coupled; and a second rear worm wheel inserted and fixed into the second rear bar bracket, and the second lifting module may further include a second worm shaft having two opposite ends at which a second front worm gear, which engages with the second front worm wheel, and a second rear worm gear, which engages with the second rear worm wheel, are provided, the second worm shaft being installed on the second cover and configured to receive a rotational force from the second lifting motor.

The first lifting motor may include a first lifting belt provided on the second drive module and connected to a first worm shaft pulley provided at an end of the first worm shaft protruding from the first cover toward the second drive module, and the first lifting motor may be disposed in parallel with the first worm shaft in which width direction of the parking robot.

The second lifting motor may include a first lifting belt provided on the second drive module and connected to a first worm shaft pulley provided at an end of the first worm shaft protruding from the first cover toward the second drive module, and the second lifting motor may be disposed in parallel with the second worm shaft in the width direction of the parking robot.

Still another embodiment of the present disclosure may provide a method of operating a parking robot, the method including: allowing two parking robots to enter a lower space of a vehicle; and positioning and deploying the two parking robots at a front wheel side and a rear wheel side of the vehicle to raise the vehicle from a ground surface and then move the vehicle to a designated parking space, in which the parking robot includes: a first drive module including first driving wheels; a second drive module including second driving wheels and provided rearward of the first drive module; a first lifting module provided between the first drive module and the second drive module; and a second lifting module provided at one side of the first lifting module and including a caster unit having a caster wheel supported from the ground surface together with the first driving wheels and the second driving wheels, and in which the first lifting module and the second lifting module are deployed to raise the front wheel or the rear wheel of the vehicle from the ground surface.

The parking robots may be moved to the front wheel side and the rear wheel side of the vehicle so that the first drive modules face each other through the lower space of the vehicle.

According to the parking robot and the method of operating the same according to the present embodiment, the parking robot may enter the lower sides of the front and rear wheel sides of the vehicle, lift the vehicle, and move the position of the vehicle to the designated parking space, such that the economical, efficient automatic parking system may be provided.

According to the parking robot according to the present embodiment, it is possible to exclude a movement passage or the like of the vehicle required for the parking space because of the rotation radius of the vehicle for implementing perpendicular parking, parallel parking, or the like, such that dense parking may be implemented, and the utilization of the parking space may be significantly improved.

According to the parking robot and the method of operating the same according to the present embodiment, the main components are modularized and compactly disposed, such that the parking robot may operate most vehicles including light vehicles with comparatively small lower spaces as well as large-scale or middle-scale vehicles with comparatively large lower spaces, which may improve the versatility of the automatic parking system implemented by the parking robot.

According to the parking robot and the method of operating the same according to the present embodiment, the modularized components are disposed in a balanced manner, such that the parking robot may be stably supported on the ground surface and smoothly travel even in a state in which a vehicle with a comparatively heavy weight is loaded, which may improve the reliability of the automatic parking system implemented by the parking robot.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a conceptual view for explaining an entrance space for a parking robot;

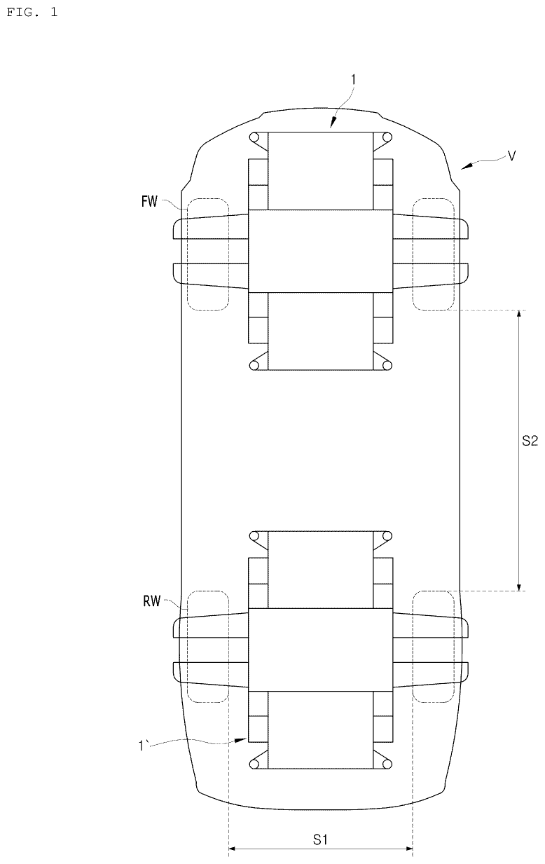

FIG. 2 is a perspective view illustrating a non-deployed state of a parking robot according to an embodiment of the present disclosure;

FIG. 3 is a front perspective view illustrating a deployed state of the parking robot according to the embodiment of the present disclosure;

FIG. 4 is a rear perspective view illustrating the deployed state of the parking robot according to the embodiment of the present disclosure;

FIG. 5 is a top plan view illustrating the non-deployed state of the parking robot according to the embodiment of the present disclosure;

FIG. 6 is a bottom plan view illustrating the deployed state of the parking robot according to the embodiment of the present disclosure;

FIG. 7 is a perspective view illustrating a disassembled state of a first drive module of the parking robot according to the embodiment of the present disclosure;

FIG. 8 is a perspective view illustrating an assembled state of the first drive module of the parking robot according to the embodiment of the present disclosure;

FIG. 9 is a perspective view illustrating a disassembled state of a second drive module of the parking robot according to the embodiment of the present disclosure;

FIG. 10 is a perspective view illustrating an assembled state of the second drive module of the parking robot according to the embodiment of the present disclosure;

FIG. 11 is a perspective view illustrating a disassembled state of a first lifting module of the parking robot according to the embodiment of the present disclosure;

FIG. 12 is a perspective view illustrating an assembled state of the first lifting module of the parking robot according to the embodiment of the present disclosure;

FIG. 13 is a perspective view illustrating a disassembled state of a second lifting module of the parking robot according to the embodiment of the present disclosure;

FIG. 14 is a perspective view illustrating an assembled state of the second lifting module of the parking robot according to the embodiment of the present disclosure;

FIG. 15 is a perspective view illustrating a disassembled state of a caster unit of the parking robot according to the embodiment of the present disclosure;

FIG. 16 is a top plan view illustrating a state in which a vehicle is lifted by the parking robot according to the embodiment of the present disclosure; and

FIG. 17 is a side view illustrating a state in which the vehicle is lifted by the parking robot according to the embodiment of the present disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, embodiments of the present disclosure will be described in detail with reference to the accompanying drawings. The following embodiments are presented to sufficiently provide the spirit of the present disclosure to those skilled in the art to which the present disclosure pertains. The present disclosure is not limited to the embodiments presented herein and may be specified as other aspects. The constituent elements irrelevant to the description of the present disclosure will be omitted from the drawings to clearly describe the present disclosure. The sizes of the constituent elements may be somewhat exaggerated for purposes of understanding.

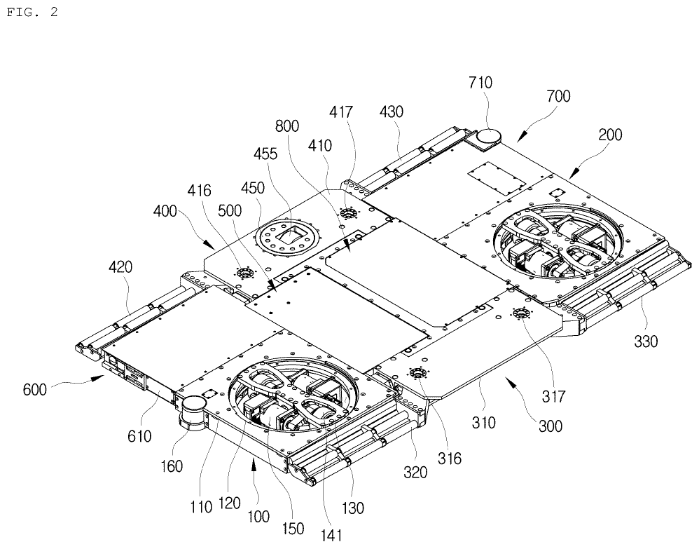

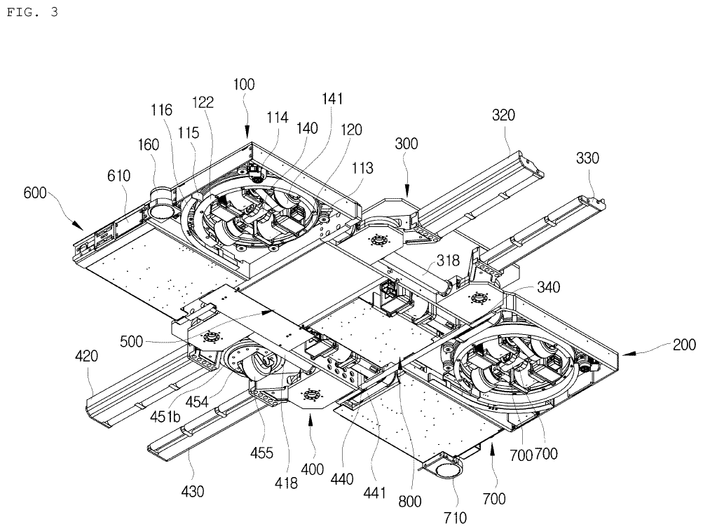

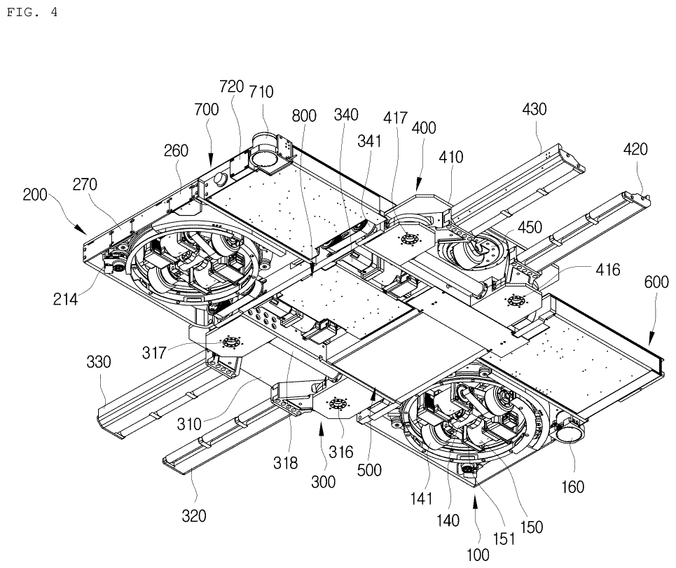

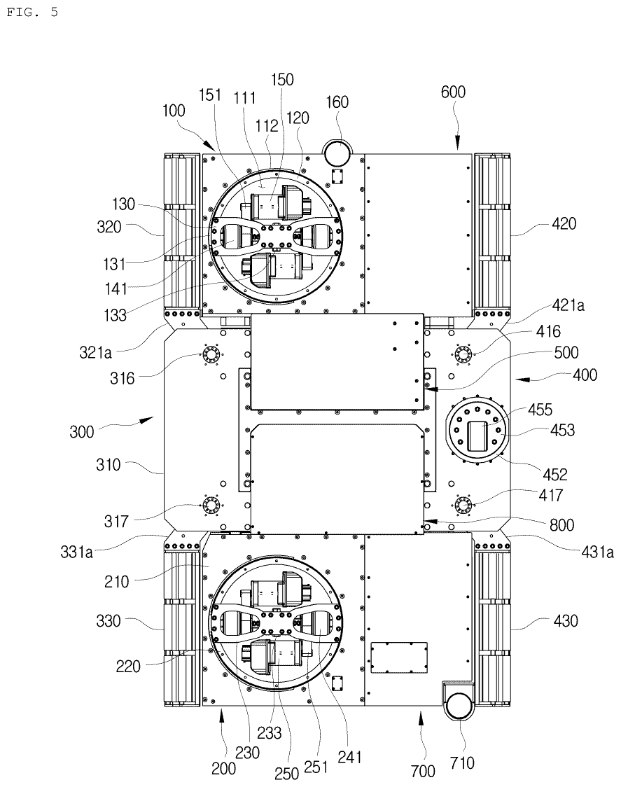

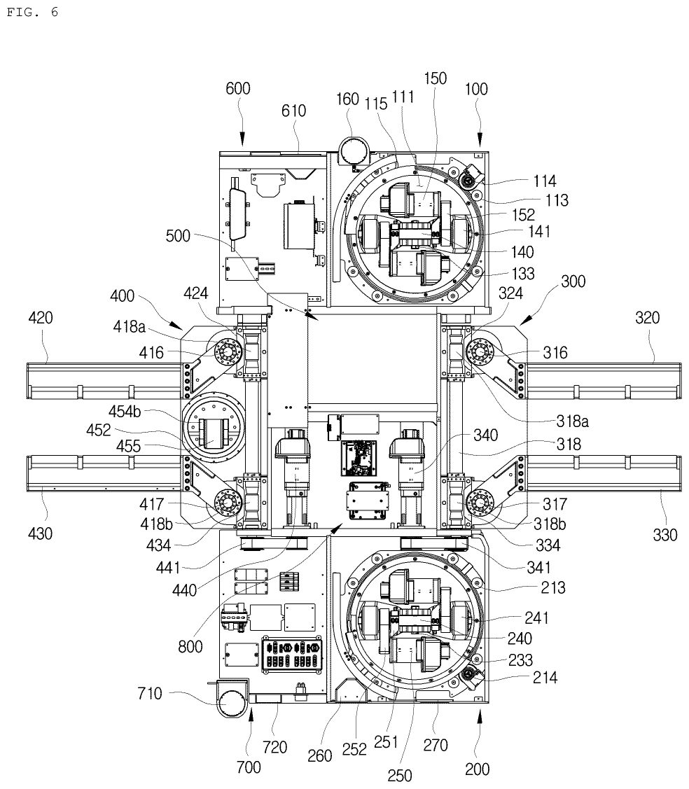

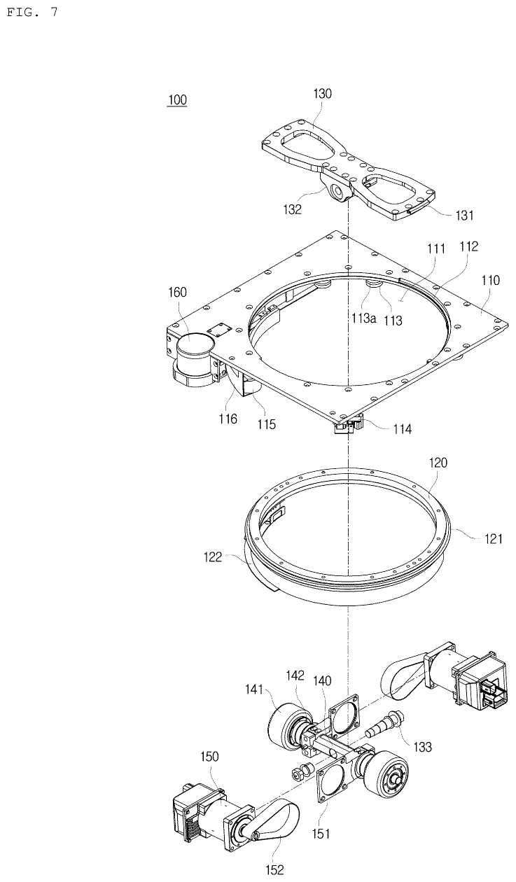

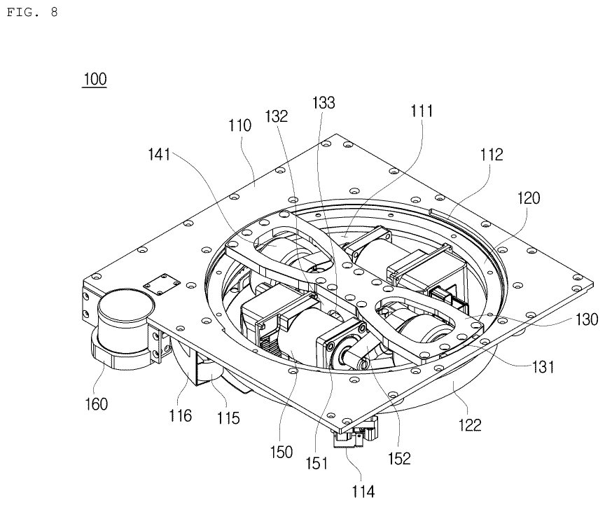

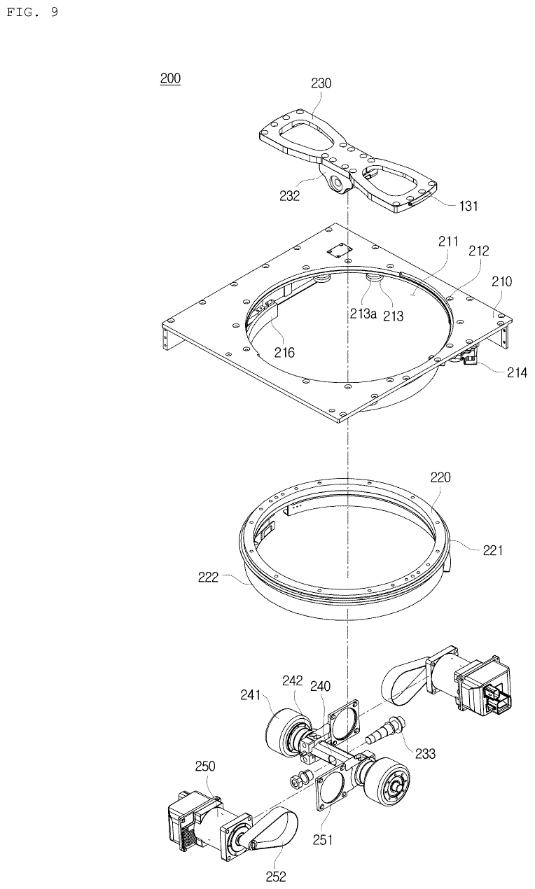

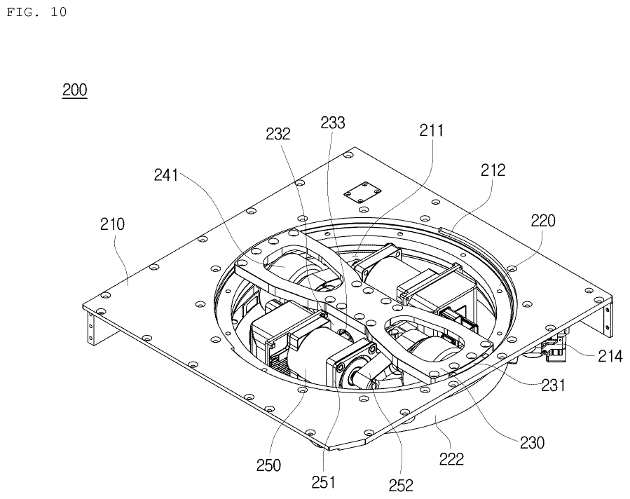

FIG. 2 is a perspective view illustrating a non-deployed state of a parking robot according to an embodiment of the present disclosure, and FIGS. 3 and 4 are front and rear perspective views illustrating deployed states of the parking robot according to the embodiment of the present disclosure. In addition, FIGS. 5 and 6 are respectively a top plan view illustrating the non-deployed state of the parking robot according to the embodiment of the present disclosure and a bottom plan view illustrating the deployed state of the parking robot according to the embodiment of the present disclosure. In addition, FIGS. 7 and 8 are perspective views illustrating disassembled and assembled states of a first drive module of the parking robot according to the embodiment of the present disclosure, and FIGS. 9 and 10 are perspective views illustrating disassembled and assembled states of a second drive module of the parking robot according to the embodiment of the present disclosure.

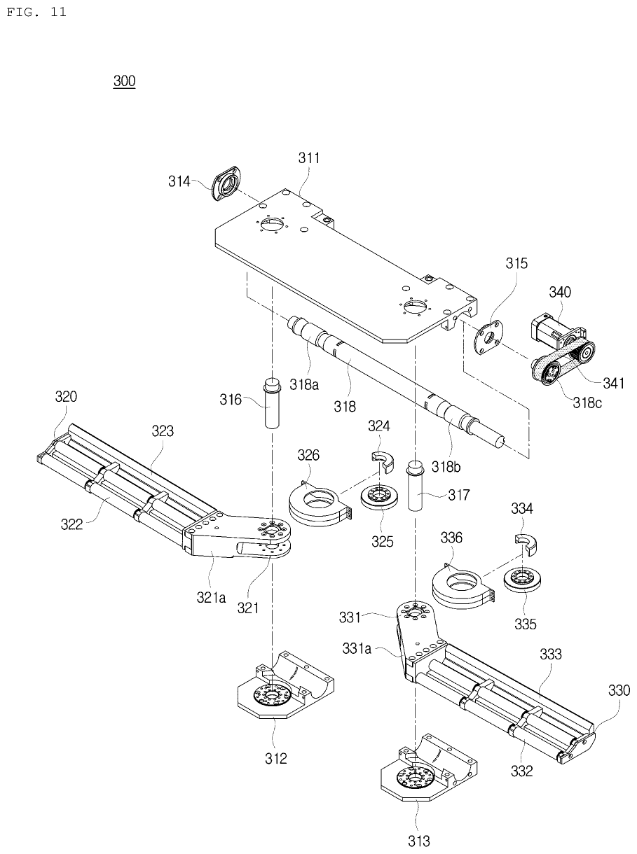

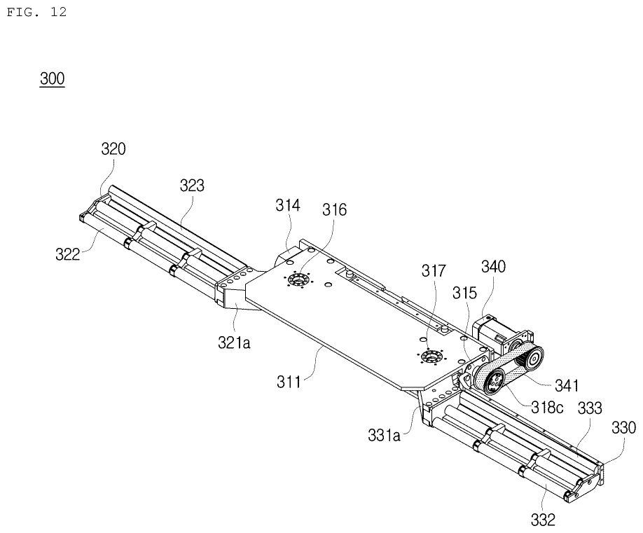

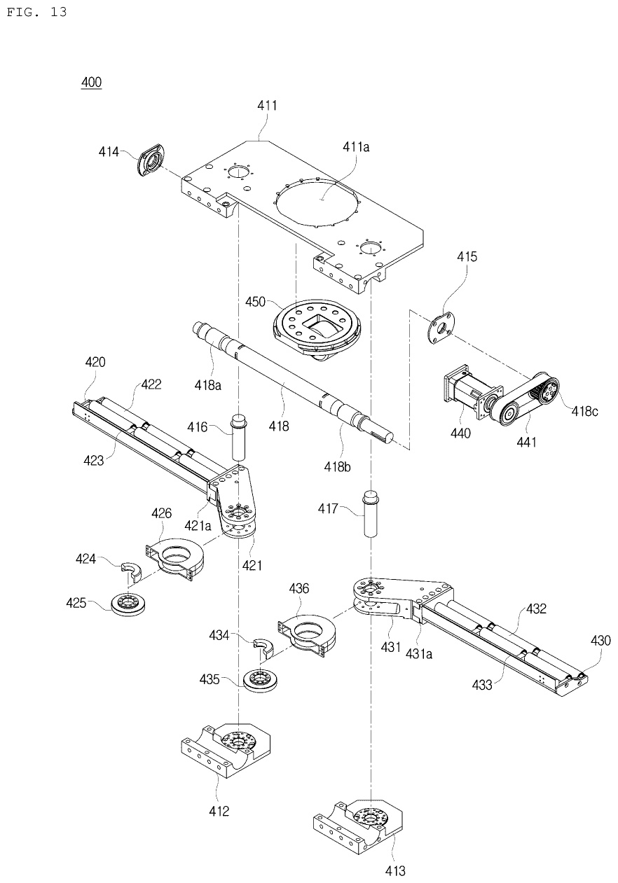

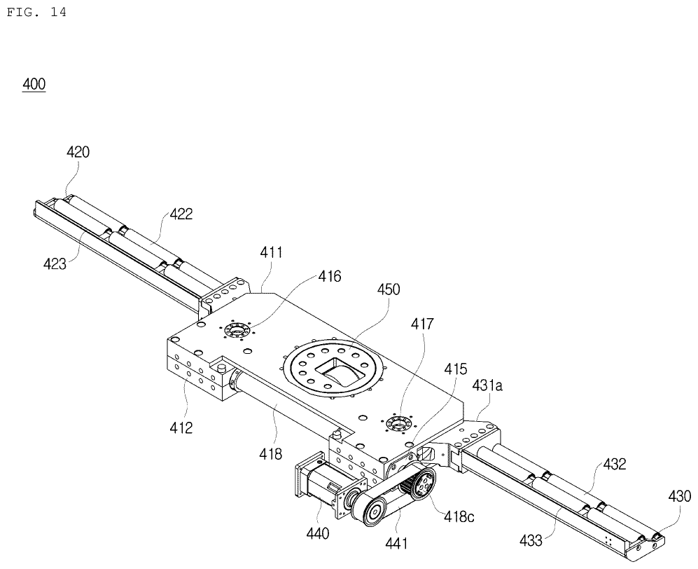

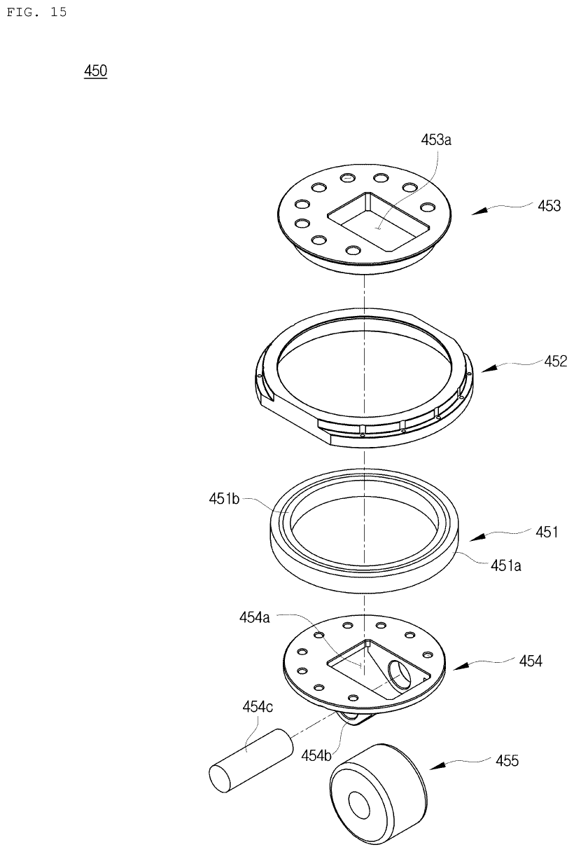

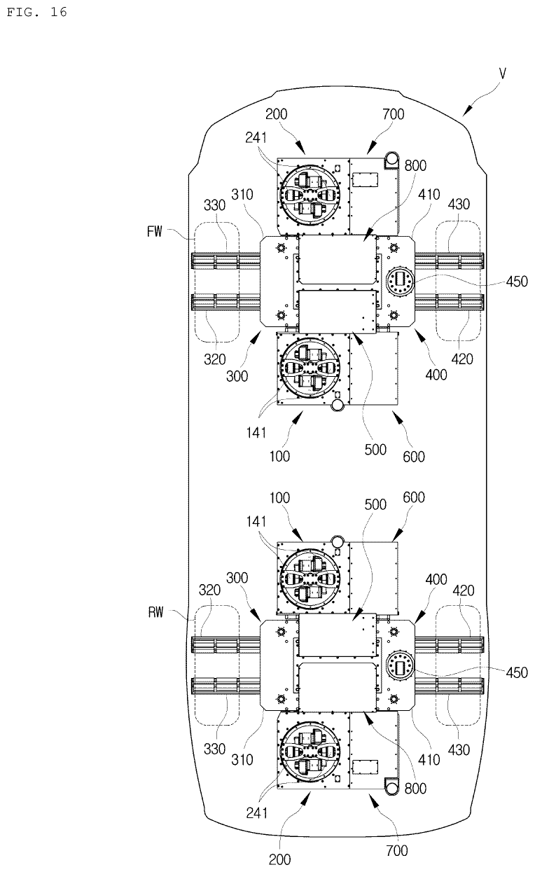

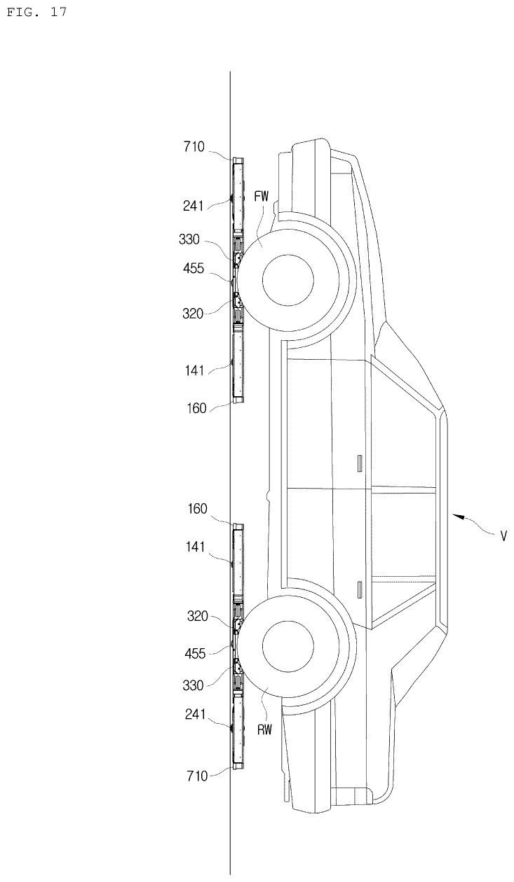

In addition, FIGS. 11 and 12 are perspective views illustrating disassembled and assembled states of a first lifting module of the parking robot according to the embodiment of the present disclosure, and FIGS. 13 and 14 are perspective views illustrating disassembled and assembled states of a second lifting module of the parking robot according to the embodiment of the present disclosure. In addition, FIG. 15 is a perspective view illustrating a disassembled state of a caster unit of the parking robot according to the embodiment of the present disclosure. In addition, FIGS. 16 and 17 are respectively a top plan view and a side view illustrating a state in which a vehicle is lifted by the parking robot according to the embodiment of the present disclosure.

First, with reference to FIGS. 2 to 6, the parking robot according to the embodiment of the present disclosure may be provided in a rectangular plate shape as a whole and include a first drive module 100, a second drive module 200, a first lifting module 300, a second lifting module 400, a battery module 500, a first control module 600, a second control module 700, and a third control module 800.

More specifically, with reference to FIG. 6, the first drive module 100 may be disposed at one side of a front side of the parking robot, the second drive module 200 may be disposed at one side of a rear side of the parking robot, and the first lifting module 300 may be disposed between the first drive module 100 and the second drive module 200 in a longitudinal direction of the parking robot. In addition, the first control module 600 may be disposed at the other side of the front side of the parking robot, the second control module 700 may be disposed at the other side of the rear side of the parking robot, and the second lifting module 400 may be disposed between the first control module 600 and the second control module 700 in the longitudinal direction of the parking robot.

That is, the first drive module 100 may be disposed at one side of the front side of the parking robot, the first control module 600 may be disposed at the other side of the front side of the parking robot, the second drive module 200 may be disposed at one side of the rear side of the parking robot, and the second control module 700 may be disposed at the other side of the rear side of the parking robot. In addition, the first lifting module 300 may be disposed at one side of a central portion of the parking robot, and the second lifting module 400 may be disposed at the other side of the central portion of the parking robot.

In addition, the battery module 500 may be provided between the first lifting module 300 and the second lifting module 400 and disposed at the front side of the parking robot, and the third control module 800 may be provided between the first lifting module 300 and the second lifting module 400 and disposed at the rear side of the parking robot. In this case, the battery module 500 and the third control module 800 may be disposed adjacent to each other in the longitudinal direction of the parking robot.

That is, the battery module 500 may be provided between the first lifting module 300 and the second lifting module 400 disposed rearward of the first drive module 100 and the first control module 600, and the third control module 800 may be provided between the first lifting module 300 and the second lifting module 400 and disposed forward of the second drive module 200 and the second control module 700, such that the battery module 500 and the third control module 800 may define the central portion of the parking robot.

In addition, hereinafter, as illustrated in FIG. 5, the non-deployed state of the parking robot according to the present disclosure refers to a state in which a first front bar 320 and a first rear bar 330 of the first lifting module 300 and a second front bar 420 and a second rear bar 430 of the second lifting module 400 are respectively folded in the longitudinal direction of the parking robot. In addition, as illustrated in FIG. 6, the deployed state of the parking robot according to the present disclosure refers to a state in which the first front bar 320 and the first rear bar 330 of the first lifting module 300 and the second front bar 420 and the second rear bar 430 of the second lifting module 400 are respectively unfolded in a width direction of the parking robot.

Meanwhile, the first drive module 100 may further include a first plate 110 having a quadrangular shape and having a first through-hole 111 formed in a central portion thereof, a first ring 120 inserted into the first through-hole 111, coupled to the first plate 110, and configured to be rotatable about a central axis of the first through-hole 111, a first tilting body 130 fastened to the first ring 120 and configured to be rotatable together with the first ring 120, a first tilting shaft 140 including first driving wheels 141 rotatably coupled to two opposite ends thereof, the first tilting shaft 140 being coupled to be inclined at a predetermined angle based on a first tilting shaft 133 provided below the first tilting body 130, and first drive motors 150 respectively fixed to the two opposite ends of the first tilting shaft 140 and configured to rotate the first driving wheels 141.

More specifically, the first plate 110 may further include a first stopper groove 112 recessed in a predetermined region of a top surface of the first plate 110 along a circumferential surface of the first through-hole 111, and a plurality of first guide rollers 113 provided on a bottom surface of the first plate 110 along the circumferential surface of the first through-hole 111. In this case, as illustrated in FIG. 7, the first guide roller 113 may include a first guide roller groove 113a recessed in an outer peripheral surface thereof in a radial direction.

In addition, the first plate 110 may further include a first steering sensor 114 provided on the bottom surface of the first plate 110, disposed adjacent to the first through-hole 111, and configured to detect a rotation angle of the first ring 120 configured to rotate about the central axis of the first through-hole 111.

In addition, in order to restrict the rotation angle of the first ring 120, the first plate 110 may further include a first cable outer bracket 116 having one end fixed to the first plate 110, and the other end provided to fix a first cable 115 fixed to the first ring 120.

As described above, the first ring 120 may be inserted and coupled into the first through-hole 111 and configured to be rotatable about the central axis of the first through-hole 111. In this case, as illustrated in FIG. 7, the first ring 120 may include a first ring protrusion portion 121 protruding in the radial direction from an outer peripheral surface of the first ring 120 so that the first ring protrusion portion 121 may be inserted into the first guide roller groove 113a. In addition, the first ring 120 may further include a first cable inner bracket 122 configured to fix the other end of the first cable 115 having one end fixed to the first cable outer bracket 116, as described above.

Therefore, the outer peripheral surface of the first ring 120 may be tightly attached to the first guide roller 113, such that the first ring 120 may stably rotate about the central axis of the first through-hole 111 from the first plate 110. An angle by which the first ring 120 may rotate from the first plate 110 may be restricted by the first cable 115 having one end fixed to the first cable outer bracket 116 and the other end fixed to the first cable inner bracket 122.

As illustrated in FIG. 7, the first tilting body 130 may be provided above the first plate 110, coupled to the first ring 120, and configured to be rotatable about the central axis of the first through-hole 111 together with the first ring 120. In this case, the first tilting body 130 may include a first stopper 131 provided at one side thereof and protruding toward the circumferential surface of the first through-hole 111 so that the first stopper 131 may be seated in the first stopper groove 112.

In addition, the first tilting body 130 may include a first center block 132 provided on a central portion of a bottom surface thereof, and the first tilting shaft 133 configured to penetrate the first center block 132 in the longitudinal direction of the parking robot.

The first tilting shaft 140 may be coupled to the first tilting shaft 133 so that one end thereof may be inclined upward or downward at a predetermined angle based on the central portion based on the longitudinal direction. Therefore, the first tilting shaft 140, together with the first tilting body 130 and the first ring 120, may rotate about the central axis of the first through-hole 111 from the first plate 110.

In addition, the first tilting shaft 140 may include the first driving wheels 141 and first driving pulleys 142 provided at the two opposite ends and configured to be rotatable from the first tilting shaft 140. In this case, the first driving wheel 141, together with the first driving pulley 142, may rotate forward or reversely from the first tilting shaft 140. In addition, the first driving wheel 141 and the first driving pulley 142, together with the first tilting shaft 140, may be inclined upward or downward with respect to the first tilting shaft 133.

The first drive motors 150 may be fastened and fixed to the first tilting shafts 140 by first drive motor brackets 151. In this case, the first drive motor brackets 151 may be respectively disposed at the front and rear sides of the parking robot according to the present disclosure based on the first tilting shaft 140.

In addition, the first drive motor 150 may further include a speed reducer configured to adjust a speed and a magnitude of a generated rotational force, and a first driving belt 152 connected to the first driving pulley 142 and configured to transmit the generated rotational force to the first driving wheel 141.

Therefore, the first drive motor 150, together with the first driving wheel 141, may be inclined upward or downward with respect to the first tilting shaft 133 by the first tilting shaft 140. In addition, the first driving wheels 141, which are provided at the two opposite ends of the first tilting shaft 140, may rotate about the central axis of the first through-hole 111 from the first plate 110 together with the first tilting shaft 140, such that rotation directions, rotational speeds, and the like may be controlled independently of one another by the first drive motors 150.

In addition, as illustrated in FIG. 2, the first drive module 100 may further include a front lidar 160 provided at the front side, disposed adjacent to the first control module 600, and configured to detect an obstacle or a moving object positioned forward of the parking robot according to the present disclosure.

Meanwhile, the second drive module 200 may further include a second plate 210 having a quadrangular shape and having a second through-hole 211 formed in a central portion thereof, a second ring 220 inserted into the second through-hole 211, coupled to the second plate 210, and configured to be rotatable about a central axis of the second through-hole 211, a second tilting body 230 fastened to the second ring 220 and configured to be rotatable together with the second ring 220, a second tilting shaft 240 including second driving wheels 241 rotatably coupled to two opposite ends thereof, the second tilting shaft 240 being coupled to be inclined at a predetermined angle based on a second tilting shaft 233 provided below the second tilting body 230, and second drive motors 250 respectively fixed to two opposite ends of the second tilting shaft 240 and configured to rotate the second driving wheels 241.

More specifically, the second plate 210 may further include a second stopper groove 212 recessed in a predetermined region of a top surface of the second plate 210 along a circumferential surface of the second through-hole 211, and a plurality of second guide rollers 213 provided on a bottom surface of the second plate 210 along the circumferential surface of the second through-hole 211. In this case, as illustrated in FIG. 9, the second guide roller 213 may include a second guide roller groove 213a recessed in an outer peripheral surface thereof in the radial direction.

In addition, the second plate 210 may further include a second steering sensor 214 provided on the bottom surface of the second plate 210, disposed adjacent to the second through-hole 211, and configured to detect a rotation angle of the second ring 220 configured to rotate about the central axis of the second through-hole 211.

In addition, in order to restrict the rotation angle of the second ring 220, the second plate 210 may further include a second cable outer bracket 216 having one end fixed to the second plate 210, and the other end provided to fix a second cable 215 fixed to the second ring 220.

As described above, the second ring 220 may be inserted and coupled into the second through-hole 211 and configured to be rotatable about the central axis of the second through-hole 211. In this case, as illustrated in FIG. 9, the second ring 220 may include a second ring protrusion portion 221 protruding in the radial direction from an outer peripheral surface of the second ring 220 so that the second ring protrusion portion 221 may be inserted into the second guide roller groove 213a. In addition, the second ring 220 may further include a second cable inner bracket 222 configured to fix the other end of the second cable 215 having one end fixed to the second cable outer bracket 216, as described above.

Therefore, the outer peripheral surface of the second ring 220 may be tightly attached to the second guide roller 213, such that the second ring 220 may stably rotate about the central axis of the second through-hole 211 from the second plate 210. An angle by which the second ring 220 may rotate from the second plate 210 may be restricted by the second cable 215 having one end fixed to the second cable outer bracket 216 and the other end fixed to the second cable inner bracket 222.

As illustrated in FIG. 9, the second tilting body 230 may be provided above the second plate 210, coupled to the second ring 220, and configured to be rotatable about the central axis of the second through-hole 211 together with the second ring 220. In this case, the second tilting body 230 may include a second stopper 231 provided at one side thereof and protruding toward the circumferential surface of the second through-hole 211 so that the second stopper 231 may be seated in the second stopper groove 212.

In addition, the second tilting body 230 may include a second center block 232 provided on a central portion of a bottom surface thereof, and a first tilting shaft 233 configured to penetrate the second center block 232 in the longitudinal direction of the parking robot.

The second tilting shaft 240 may be coupled to the second tilting shaft 233 so that one end thereof may be inclined upward or downward at a predetermined angle based on the central portion based on the longitudinal direction. Therefore, the second tilting shaft 240, together with the second tilting body 230 and the second ring 220, may rotate about the central axis of the second through-hole 211 from the second plate 210.

In addition, the second tilting shaft 240 may include the second driving wheels 241 and second driving pulleys 242 provided at the two opposite ends and configured to be rotatable from the second tilting shaft 240. In this case, the second driving wheel 241, together with the second driving pulley 242, may rotate rearward or reversely from the second tilting shaft 240. In addition, the second driving wheel 241 and the second driving pulley 242, together with the second tilting shaft 240, may be inclined upward or downward with respect to the second tilting shaft 233.

The second drive motors 250 may be fastened and fixed to the second tilting shaft 240 by second drive motor brackets 251. In this case, the second drive motor brackets 251 may be respectively disposed at the front and rear sides of the parking robot according to the present disclosure based on the second tilting shaft 240.

In addition, the second drive motor 250 may further include a speed reducer configured to adjust a speed and a magnitude of a generated rotational force, and a second driving belt 252 connected to the second driving pulley 242 and configured to transmit the generated rotational force to the second driving wheel 241.

Therefore, the second drive motor 250, together with the second driving wheel 241, may be inclined upward or downward with respect to the second tilting shaft 233 by the second tilting shaft 240. In addition, the second driving wheels 241, which are provided at the two opposite ends of the second tilting shaft 240, may rotate about the central axis of the second through-hole 211 from the second plate 210 together with the second tilting shaft 240, such that rotation directions, rotational speeds, and the like may be controlled independently of one another by the second drive motors 250.

In addition, as illustrated in FIG. 4, the second drive module 200 may include a rear camera 260 provided at a rear side thereof, disposed adjacent to the second control module 700, and configured to capture an image of the rear side of the parking robot according to the present disclosure. Further, as illustrated in FIG. 4, the second drive module 200 may further include a first lighting device 270 disposed at a rear side thereof and configured to illuminate the rear side of the parking robot according to the present disclosure.

Meanwhile, as illustrated in FIGS. 11 and 12, the first lifting module 300 may include a first lifting motor 340 configured to simultaneously rotate the first front bar 320 and the first rear bar 330 to the deployed state or the non-deployed state from a first cover 310 about a first front bar rotation shaft 316 provided at a front side of the first cover 310 and a first rear bar rotation shaft 317 provided at a rear side of the first cover 310.

The first cover 310 may include a first upper cover 311, a first front lower cover 312 fastened to a lower side of a front side of the first upper cover 311, a first rear lower cover 313 fastened to a lower side of a rear side of the first upper cover 311, a first front cover 314 fastened to a front end side of the first cover 310, and a first rear cover 315 fastened to a rear end side of the first cover 310.

In addition, the first cover 310 may further include the first front bar rotation shaft 316 provided between the front side of the first upper cover 311 and the first front lower cover 312, the first rear bar rotation shaft 317 provided between the rear side of the first upper cover 311 and the first rear lower cover 312, and a first worm shaft 318 disposed from the front end side toward the rear side of the first cover 310.

In this case, the first worm shaft 318 may include a first front worm gear 318a provided at a front side thereof, and a first rear worm gear 318b provided at a rear side thereof.

In addition, the first front worm gear 318a is fastened between the front side of the first upper cover 311 and the first front lower cover 312, and the first rear worm gear 318b is fastened between the rear side of the first upper cover 311 and the first rear lower cover 313, such that the first worm shaft 318 may be rotatably provided in the first cover 310. In addition, a front end side of the first worm shaft 318 may be supported by the first front cover 314, and a rear end side of the first worm shaft 318 may penetrate the first rear cover 315 and protrude rearward from the first cover 310. In this case, the first worm shaft 318 may further include a first worm shaft pulley 318c provided at the rear end side that penetrates the first rear cover 315 and protrudes rearward from the first cover 310, as described above.

The first front bar 320 may include a first front bar bracket 321 to which the first front bar rotation shaft 316 is penetratively coupled, a first front worm wheel 324 inserted into the first front bar bracket 321, disposed on an outer peripheral surface of the first front bar rotation shaft 316, and configured to engage with the first front worm gear 318a, a first front worm wheel shaft 325 configured to support the first front worm wheel 324 and inserted into the first front bar bracket 321, and a first front oil cap 326 inserted into the first front bar bracket 321 and configured to provide lubrication oil between the first front worm gear 318a and the first front worm wheel 324.

In addition, the first front bar 320 may further include a first front bar bent portion 321a formed at a side of the first front bar bracket 321. In this case, as illustrated in FIG. 6, the first front bar bent portion 321a may be bent so that one end of the first front bar 320, at which the first front bar bracket 321 is formed, may be disposed to be closer to the front side of the parking robot than the other end of the first front bar 320 to the front side of the parking robot when the first front bar 320 is in the deployed state.

In addition, the first front bar 320 may further include first front bar rollers 322 configured to be rotatable about rotation axes defined in a longitudinal direction of the first front bar 320. In this case, as illustrated in FIG. 2, the first front bar rollers 322 may be provided as a plurality of first front bar rollers 322 provided on the plurality of rotation axes having heights that decrease from the inside toward the outside of the parking robot when the first front bar 320 is not deployed. In addition, the first front bar 320 may further include a first front bar catching projection 323 protruding upward from the inside of the parking robot when the first front bar 320 is not deployed.

The first rear bar 330 may include a first rear bar bracket 331 to which the first rear bar rotation shaft 317 is penetratively coupled, a first rear worm wheel 334 inserted into the first rear bar bracket 331, disposed on an outer peripheral surface of the first rear bar rotation shaft 317, and configured to engage with the first rear worm gear 318b, a first rear worm wheel shaft 335 configured to support the first rear worm wheel 334 and inserted into the first rear bar bracket 331, and a first rear oil cap 336 inserted into the first rear bar bracket 331 and configured to provide lubrication oil between the first rear worm gear 318b and the first rear worm wheel 334.

In addition, the first rear bar 330 may further include a first rear bar bent portion 331a formed at a side of the first rear bar bracket 331. In this case, as illustrated in FIG. 6, the first rear bar bent portion 331a may be bent so that one end of the first rear bar 330, at which the first rear bar bracket 331 is formed, may be disposed to be closer to the rear side of the parking robot than the other end of the first rear bar 330 to the rear side of the parking robot when the first rear bar 330 is in the deployed state.

In addition, the first rear bar 330 may further include first rear bar rollers 332 configured to be rotatable about rotation axes defined in a longitudinal direction of the first rear bar 330. In this case, as illustrated in FIG. 2, the first rear bar rollers 332 may be provided as a plurality of first rear bar rollers 332 provided on the plurality of rotation axes having heights that decrease from the inside toward the outside of the parking robot when the first rear bar 330 is not deployed. In addition, the first rear bar 330 may further include a first rear bar catching projection 333 protruding upward from the inside of the parking robot when the first rear bar 330 is not deployed.

As illustrated in FIG. 6, the first lifting motor 340 may be disposed between the first cover 310 and the third control module 800. In this case, a rotary shaft of the first lifting motor 340 may be disposed in parallel with a rotation axis of the first worm shaft 318. In addition, the first lifting motor 340 may further include a speed reducer that may adjust a speed and a magnitude of an outputted rotational force.

In addition, the rotational force generated from the first lifting motor 340 may be transmitted to the first worm shaft 318 through a first lifting belt 341 connected to the first worm shaft pulley 318c. Therefore, when the first worm shaft 318 is rotated in one direction by the first lifting motor 340 in the non-deployed state of the first lifting module 300, the first front bar 320 and the first rear bar 330 may be simultaneously rotated at 90° and deployed. In addition, when the first worm shaft 318 is rotated in a reverse direction by the first lifting motor 340 in the deployed state of the first lifting module 300, the first front bar 320 and the first rear bar 330 may be simultaneously rotated at 90° and returned to the non-deployed state.

In addition, as illustrated in FIG. 6, the first lifting motor 340 may be disposed to be embedded at one side of the third control module 800, and the rotary shaft of the first lifting motor 340 and the first lifting belt 341 may be disposed to be embedded at a front side of the second drive module 200.

Meanwhile, as illustrated in FIGS. 13 and 14, the second lifting module 400 may include a second lifting motor 440 configured to simultaneously rotate the second front bar 420 and the second rear bar 430 to the deployed state or the non-deployed state from a second cover 410 about a second front bar rotation shaft 416 provided at a front side of the second cover 410 and a second rear bar rotation shaft 417 provided at a rear side of the second cover 410. In addition, the second lifting module 400 may further include a caster unit 450 disposed on the second cover 410, provided between the second front bar rotation shaft 416 and the second rear bar rotation shaft 417, and configured to support the second lifting module 400 from the ground surface.

The second cover 410 may include a second upper cover 411, a second front lower cover 412 fastened to a lower side of a front side of the second upper cover 411, a second rear lower cover 413 fastened to a lower side of a rear side of the second upper cover 411, a second front cover 414 fastened to a front end side of the second cover 410, and a second rear cover 415 fastened to a rear end side of the second cover 410.

In addition, the second cover 410 may further include the second front bar rotation shaft 416 provided between the front side of the second upper cover 411 and the second front lower cover 412, the second rear bar rotation shaft 417 provided between the rear side of the second upper cover 411 and the second rear lower cover 412, and a second worm shaft 418 disposed from the front end side toward the rear side of the second cover 410.

In this case, the second worm shaft 418 may include a second front worm gear 418a provided at a front side thereof, and a second rear worm gear 418b provided at a rear side thereof.

In addition, the second front worm gear 418a is fastened between the front side of the second upper cover 411 and the second front lower cover 412, and the second rear worm gear 418b is fastened between the rear side of the second upper cover 411 and the second rear lower cover 413, such that the second worm shaft 418 may be rotatably provided in the second cover 410. In addition, a front end side of the second worm shaft 418 may be supported by the second front cover 414, and a rear end side of the second worm shaft 418 may penetrate the second rear cover 415 and protrude rearward from the second cover 410. In this case, the second worm shaft 418 may further include a second worm shaft pulley 418c provided at the rear end side that penetrates the second rear cover 415 and protrudes rearward from the second cover 410, as described above.

The second front bar 420 may include a second front bar bracket 421 to which the second front bar rotation shaft 416 is penetratively coupled, a second front worm wheel 424 inserted into the second front bar bracket 421, disposed on an outer peripheral surface of the second front bar rotation shaft 416, and configured to engage with the second front worm gear 418a, a second front worm wheel shaft 425 configured to support the second front worm wheel 424 and inserted into the second front bar bracket 421, and a second front oil cap 426 inserted into the second front bar bracket 421 and configured to provide lubrication oil between the second front worm gear 418a and the second front worm wheel 424.

In addition, the second front bar 420 may further include a second front bar bent portion 421a formed at a side of the second front bar bracket 421. In this case, as illustrated in FIG. 6, the second front bar bent portion 421a may be bent so that one end of the second front bar 420, at which the second front bar bracket 421 is formed, may be disposed to be closer to the front side of the parking robot than the other end of the second front bar 420 to the front side of the parking robot when the second front bar 420 is in the deployed state.

In addition, the second front bar 420 may further include second front bar rollers 422 configured to be rotatable about rotation axes defined in a longitudinal direction of the second front bar 420. In this case, as illustrated in FIG. 2, the second front bar rollers 422 may be provided as a plurality of second front bar rollers 422 provided on the plurality of rotation axes having heights that decrease from the inside toward the outside of the parking robot when the second front bar 420 is not deployed. In addition, the second front bar 420 may further include a second front bar catching projection 423 protruding upward from the inside of the parking robot when the second front bar 420 is not deployed.

The second rear bar 430 may include a second rear bar bracket 431 to which the second rear bar rotation shaft 417 is penetratively coupled, a second rear worm wheel 434 inserted into the second rear bar bracket 431, disposed on an outer peripheral surface of the second rear bar rotation shaft 417, and configured to engage with the second rear worm gear 418b, a second rear worm wheel shaft 435 configured to support the second rear worm wheel 434 and inserted into the second rear bar bracket 431, and a second rear oil cap 436 inserted into the second rear bar bracket 431 and configured to provide lubrication oil between the second rear worm gear 418b and the second rear worm wheel 434.

In addition, the second rear bar 430 may further include a second rear bar bent portion 431a formed at a side of the second rear bar bracket 431. In this case, as illustrated in FIG. 6, the second rear bar bent portion 431a may be bent so that one end of the second rear bar 430, at which the second rear bar bracket 431 is formed, may be disposed to be closer to the rear side of the parking robot than the other end of the second rear bar 430 to the rear side of the parking robot when the second rear bar 430 is in the deployed state.

In addition, the second rear bar 430 may further include second rear bar rollers 432 configured to be rotatable about rotation axes defined in a longitudinal direction of the second rear bar 430. In this case, as illustrated in FIG. 2, the second rear bar rollers 432 may be provided as a plurality of second rear bar rollers 432 provided on the plurality of rotation axes having heights that decrease from the inside toward the outside of the parking robot when the second rear bar 430 is not deployed. In addition, the second rear bar 430 may further include a second rear bar catching projection 433 protruding upward from the inside of the parking robot when the second rear bar 430 is not deployed.

As illustrated in FIG. 6, the second lifting motor 440 may be disposed between the second cover 410 and the third control module 800. In this case, a rotary shaft of the second lifting motor 440 may be disposed in parallel with a rotation axis of the second worm shaft 418. In addition, the second lifting motor 440 may further include a speed reducer that may adjust a speed and a magnitude of an outputted rotational force.

In addition, the rotational force generated from the second lifting motor 440 may be transmitted to the second worm shaft 418 through a second lifting belt 441 connected to the second worm shaft pulley 418c. Therefore, when the second worm shaft 418 is rotated in one direction by the second lifting motor 440 in the non-deployed state of the second lifting module 400, the second front bar 420 and the second rear bar 430 may be simultaneously rotated at 90° and deployed. In addition, when the second worm shaft 418 is rotated in a reverse direction by the second lifting motor 440 in the deployed state of the second lifting module 400, the second front bar 420 and the second rear bar 430 may be simultaneously rotated at 90° and returned to the non-deployed state.

In addition, as illustrated in FIG. 6, the second lifting motor 440 may be disposed to be embedded at the other side of the third control module 800, and the rotary shaft of the second lifting motor 440 and the second lifting belt 441 may be disposed to be embedded at a front side of the second control module 700. That is, the second lifting motor 440 may be provided symmetrically with the first lifting motor 340 with respect to the third control module 800 in the width direction of the parking robot.

The arrangement structures of the first lifting motor 340 and the second lifting motor 440 may reduce the overall size of the parking robot, thereby enabling the parking robot to enter lower sides of most vehicles including light vehicles with comparatively small lower spaces as well as large-scale or middle-scale vehicles with comparatively large lower spaces.

Meanwhile, the caster unit 450 may include an annular bearing 451, a bearing casing 452 fixedly coupled to a caster unit fastening hole 411a, a bearing upper cover 453 rotatably coupled to an inner peripheral surface of the bearing casing 452, a bearing lower cover 454 fastened to a lower side of the bearing upper cover 453, and a caster wheel 455 rotatably coupled to the bearing lower cover 454.

More specifically, the bearing 451 may be configured such that an inner race 451b rotates relative to an outer race 451a. In addition, the bearing casing 452 may be formed in an annular shape, and the bearing 451 may be fixedly coupled to the bearing casing 452 so that at least a part of the outer race 451a is supported on an inner peripheral surface of the bearing casing 452. Therefore, in the state in which the outer race 451b of the bearing 451 is fixed to the bearing casing 452, the inner race 451b may rotate about a central axis of the caster unit fastening hole 411a from the second upper cover 411.

The bearing upper cover 453 may include a bearing upper cover opening 453a perpendicularly formed through a central portion thereof, and the bearing upper cover 453 may be provided to surround at least a part of the inner race 451b, except for the bottom surface of the inner race 451b, and rotatably coupled to the inner peripheral surface of the bearing casing 452. In addition, the bearing lower cover 454 may include a bearing lower cover opening 454a perpendicularly formed through a central portion thereof, and the bearing lower cover 454 may be provided to support at least a part of the bottom surface of the inner race 451b and fastened to a lower side of the bearing upper cover 453. In this case, the bearing upper cover opening 453a and the bearing lower cover opening 454a may be formed to communicate with each other.

In addition, the bearing lower cover 454 may further include a caster wheel fastening portion 454b protruding downward from a bottom surface thereof and configured to fasten the caster wheel 455. In this case, the caster wheel 455 may be fastened to the caster wheel fastening portion 454b and configured to be rotatable about a caster wheel rotation shaft 454c. An upper end of the caster wheel 455 protrudes toward a bottom surface of the bearing lower cover 454 without protruding toward a top surface of the bearing upper cover 453, which may prevent an increase in overall height of the caster unit 450.

In addition, the caster wheel 455, together with the bearing upper cover 453, the bearing lower cover 454, and the inner race 451b, may rotate about the central axis of the caster unit fastening hole 411a from the second upper cover 411 and simultaneously rotate about the caster wheel rotation shaft 454c.

Therefore, the parking robot according to the present disclosure may move in a state of being supported at three points from the ground surface by the first driving wheels 141 provided at one side of the front side, the second driving wheels 241 provided at one side of the rear side, and the caster wheel 455 provided at the other side of the central portion.

Meanwhile, the battery module 500 may be provided in a quadrangular plate shape as a whole. As described above, the battery module 500 may include a battery (not illustrated) provided between the first lifting module 300 and the second lifting module 400, disposed rearward of the first drive module 100 and the first control module 600, and configured to supply necessary power to the first drive module 100, the second drive module 200, the first lifting module 300, the second lifting module 400, the first control module 600, the second control module 700, and the third control module 800. In this case, the battery may be charged in a contact or non-contact manner and provided to be embedded or replaceable.

In addition, the battery module 500 is disposed in a central region based on the width direction and the longitudinal direction of the parking robot, which makes it easy to install lines for supplying power to the modules. The battery module 500 is formed to have a comparatively heavy weight, such that the parking robot may be more stably supported at the three points from the ground surface by the first driving wheels 141, the second driving wheels 241, and the caster wheel 455.

Meanwhile, the first control module 600 may be provided in a quadrangular plate shape as a whole and provided at the other side of the front side of the parking robot. That is, the first control module 600, together with the first drive module 100, may constitute the front side of the parking robot.

In addition, the first control module 600 may include a printed circuit board (PCB) or the like on which various types of electronic elements and the like for controlling the first drive module 100, the second drive module 200, the first lifting module 300, and the second lifting module 400 are mounted.

In addition, the first control module 600 may include a front camera 610 provided at a front side thereof and configured to capture an image of an object, an obstacle, or the like provided forward of the parking robot. In this case, as illustrated in FIG. 2, the front camera 610 may be disposed adjacent to a first lidar 170.

Meanwhile, the second control module 700 may be provided in a quadrangular plate shape as a whole and provided at the other side of the rear side of the parking robot. That is, the second control module 700, together with the second drive module 200, may constitute the rear side of the parking robot.

In addition, like the first control module 600, the second control module 700 may include a printed circuit board (PCB) or the like on which various types of electronic elements and the like for controlling the first drive module 100, the second drive module 200, the first lifting module 300, and the second lifting module 400 are mounted.

In addition, as illustrated in FIG. 4, the second control module 700 may include a rear lidar 710 disposed at the rear side and configured to detect an obstacle or a moving object positioned rearward of the parking robot according to the present disclosure. In addition, the second control module 700 may further include a second lighting device 720 disposed at the rear side, provided symmetrically with the first lighting device 270 in the width direction of the parking robot center, and configured to illuminate the rear side of the parking robot according to the present disclosure.

Meanwhile, the third control module 800 may be provided in a quadrangular plate shape as a whole, disposed between the first lifting module 300 and the second lifting module 400, and configured to define the central region in the width direction and the longitudinal direction of the parking robot together with the battery module 500. More specifically, as illustrated in FIG. 6, the third control module 800 may be provided between the first lifting motor 340 and the second lifting motor 440.

In addition, the third control module 800 may include a printed circuit board (PCB) or the like on which various types of electronic elements and the like for controlling the first drive module 100, the second drive module 200, the first lifting module 300, and the second lifting module 400 are mounted.

Meanwhile, a method of operating the parking robot according to the present disclosure configured as described above will be described with reference to FIGS. 16 and 17.

First, in order to move one vehicle V to a designated parking space, two parking robots in the non-deployed state enter the lower space of the vehicle V. In this case, one parking robot is provided adjacent to front wheels FW, and the other parking robot is positioned adjacent to rear wheels RW.

More specifically, the parking robot positioned adjacent to the rear wheels RW may be aligned such that the first drive module 100 and the first control module 600 are disposed toward the front side of the vehicle V, and the second drive module 200 and the second control module 700 are disposed toward the rear side of the vehicle V. Therefore, a bottom surface of the rear side of the vehicle V may be illuminated by the first lighting device 270 and the second lighting device 720 provided on the first drive module 200 and the second control module 700.

In addition, an obstacle, a moving object, or the like positioned rearward of the vehicle V may be detected by the rear lidar 710 provided on the second control module 700, and an image of the rear side of the vehicle V may be captured by the rear camera 260 provided on the second drive module 200.

The parking robot positioned adjacent to the front wheels FW may be aligned such that the first drive module 100 and the first control module 600 are disposed toward the rear side of the vehicle V, and the second drive module 200 and the second control module 700 are disposed toward the front side of the vehicle V. Therefore, a bottom surface of the front side of the vehicle V may be illuminated by the first lighting device 270 and the second lighting device 720 provided on the first drive module 200 and the second control module 700.

In addition, an obstacle, a moving object, or the like positioned forward of the vehicle V may be detected by the rear lidar 710 provided on the second control module 700, and an image of the front side of the vehicle V may be captured by the rear camera 260 provided on the second drive module 200.

In addition, as described above, the parking robot aligned adjacent to the front wheels FW or the rear wheels RW may identify whether the other parking robot is properly aligned adjacent to the rear wheels RW or the front wheels FW by means of the front lidar 160.

Meanwhile, as described above, when the parking robots are completely aligned adjacent to the front wheels FW and the rear wheels RW of the vehicle V, the first front bar 320, the first rear bar 330, the second front bar 420, and the second rear bar 430 of the parking robot aligned adjacent to the front wheels FW are simultaneously unfolded and deployed in the width direction of the parking robot, such that the front wheels FW are raised from the ground surface, as illustrated in FIG. 16. In this case, front sides of the front wheels FW are seated on the first rear bar 330 and the second rear bar 430 along the first rear bar rollers 332 and the second rear bar rollers 432, and rear sides of the front wheels FW are seated on the first front bar 320 and the second front bar 420 along the first front bar rollers 322 and the second front bar rollers 422.

In this case, the first rear bar catching projection 333 and the second rear bar catching projection 433 may prevent the front sides of the front wheels FW from departing from the first rear bar 330 and the second rear bar 430. In addition, the first front bar catching projection 323 and the second front bar catching projection 423 may prevent the rear sides of the front wheels FW from departing from the first front bar 320 and the second front bar 420.

In addition, the first front bar 320, the first rear bar 330, the second front bar 420, and the second rear bar 430 of the parking robot aligned adjacent to the rear wheels RW are simultaneously unfolded and deployed in the width direction of the parking robot, such that the rear wheels RW are raised from the ground surface. In this case, the front sides of the rear wheels RW are seated on the first front bar 320 and the second front bar 420 along the first front bar rollers 322 and the second front bar rollers 422, and the front sides of the rear wheels RW are seated on the first rear bar 330 and the second rear bar 430 along the first rear bar rollers 332 and the second rear bar rollers 432.

In this case, the first front bar catching projection 323 and the second front bar catching projection 423 may prevent the front sides of the rear wheels FW from departing from the first front bar 320 and the second front bar 420. In addition, the first rear bar catching projection 333 and the second rear bar catching projection 433 may prevent the rear sides of the rear wheels FW from departing from the first rear bar 330 and the second rear bar 430.

In addition, as illustrated in FIG. 6, in the deployed state of the parking robot, even the vehicle V, which have the wheels with comparatively small diameters, may be raised from the ground surface by the first front bar bent portion 321a and the first rear bar bent portion 331a, which are provided to enable the first front bar 320 and the first rear bar 330 to be deployed to be closer to the center based on the longitudinal direction of the parking robot than the first front bar rotation shaft 316 and the first rear bar rotation shaft 317, and the second front bar bent portion 421a and the second rear bar bent portion 431a, which are provided to enable the second front bar 420 and the second rear bar 430 to be deployed to be closer to the center based on the longitudinal direction of the parking robot than the second front bar rotation shaft 416 and the second rear bar rotation shaft 417.

Thereafter, the two parking robots, onto which the vehicle V is loaded, are moved to the designated parking space while identifying the positions thereof, and then the first front bars 320, the first rear bars 330, the second front bars 420, and the second rear bars 430 come into the non-deployed state by being simultaneously folded in the longitudinal direction of the parking robot, such that the vehicle V may be completely parked. Thereafter, the parking robots may return to a designated location and then be on standby, or the parking robots may move to park another vehicle V.

While the specific embodiments of the parking robot according to the present disclosure have been described above, it is apparent that various modifications may be made without departing from the scope of the present disclosure.

Therefore, the scope of the present disclosure should not be limited to the described embodiments, and should be defined by not only the claims to be described below, but also those equivalent to the claims.

That is, it should be understood that the aforementioned exemplary embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

What is claimed is:

1. A parking robot comprising:
a first drive module comprising first driving wheels;
a second drive module comprising second driving wheels and provided rearward of the first drive module;
a first lifting module disposed between the first drive module and the second drive module; and
a second lifting module provided at one side of the first lifting module,
wherein the second lifting module comprises a caster unit having a caster wheel supported from a ground surface together with the first driving wheels and the second driving wheels.

2. The parking robot of claim 1, further comprising:
a first control module provided forward of the second lifting module;
a second control module provided rearward of the second lifting module;
a battery module provided between the first lifting module and the second lifting module and provided rearward of the first drive module and the first control module; and
a third control module provided between the first lifting module and the second lifting module and provided forward of the second drive module and the second control module.

3. The parking robot of claim 1, wherein the first drive module comprises:
a first plate having a first through-hole formed in a central portion thereof;
a first ring coupled to the first plate and configured to be rotatable about a central axis of the first through-hole;
a first tilting body comprising a first tilting shaft and fastened to the first ring;
a first tilting shaft having two opposite ends at which the first driving wheels are rotatably provided, the first tilting shaft being coupled to the first tilting shaft so that any one side thereof is inclined upward or downward with respect to the first tilting shaft; and
first drive motors respectively fixed to front and rear sides of the first tilting shaft by first drive motor brackets and configured to independently rotate the first driving wheels, and
wherein the second drive module comprises:
a second plate having a second through-hole formed in a central portion thereof;
a second ring coupled to the second plate and configured to be rotatable about a central axis of the second through-hole;
a second tilting body comprising a second tilting shaft and fastened to the second ring;
a second tilting shaft having two opposite ends at which the second driving wheels are rotatably provided, the second tilting shaft being coupled to the second tilting shaft so that any one side thereof is inclined upward or downward with respect to the second tilting shaft; and
second drive motors respectively fixed to front and rear sides of the second tilting shaft by second drive motor brackets and configured to independently rotate the second driving wheels.

4. The parking robot of claim 3, wherein the first plate further comprises:
a plurality of first guide rollers provided on a bottom surface of the first plate along a circumferential surface of the first through-hole and configured to guide a rotation of the first ring; and
a first stopper groove provided on a top surface of the first plate along the circumferential surface of the first through-hole,
wherein the first tilting body further comprises a first stopper inserted into the first stopper groove and configured to restrict a rotation angle of the first ring from the first plate,
wherein the second plate further comprises:
a plurality of second guide rollers provided on a bottom surface of the second plate along a circumferential surface of the second through-hole and configured to guide a rotation of the second ring; and
a second stopper groove provided on a top surface of the second plate along the circumferential surface of the second through-hole, and
wherein the second tilting body further comprises a second stopper inserted into the second stopper groove and configured to restrict a rotation angle of the second ring from the second plate.

5. The parking robot of claim 3, wherein the first drive module comprises a first cable having one end fixed to a first cable outer bracket provided on the first plate, and the other end fixed to a first cable inner bracket provided on the first ring, the first cable being configured to restrict a rotation angle of the first ring, and
wherein the second drive module comprises a second cable having one end fixed to a second cable outer bracket provided on the second plate, and the other end fixed to a second cable inner bracket provided on the second ring, the second cable being configured to restrict a rotation angle of the second ring.

6. The parking robot of claim 2, wherein the first lifting module comprises:
a first cover comprising a first front bar rotation shaft provided at a front side of the parking robot, and a first rear bar rotation shaft provided at a rear side of the parking robot;
a first front bar configured to be folded toward the front side of the parking robot with respect to the first cover based on the first front bar rotation shaft or unfolded in a width direction of the parking robot;
a first rear bar configured to be folded toward the rear side of the parking robot with respect to the first cover based on the first rear bar rotation shaft or unfolded in the width direction of the parking robot; and
a first lifting motor configured to provide a rotational force so that the first front bar and the first rear bar are simultaneously folded or unfolded, and
wherein the second lifting module comprises:
a second cover comprising a second front bar rotation shaft provided at the front side of the parking robot, and a second rear bar rotation shaft provided at the rear side of the parking robot;
a second front bar configured to be folded toward the front side of the parking robot with respect to the second cover based on the second front bar rotation shaft or unfolded in the width direction of the parking robot;
a second rear bar configured to be folded toward the rear side of the parking robot with respect to the second cover based on the second rear bar rotation shaft or unfolded in the width direction of the parking robot; and
a second lifting motor configured to provide a rotational force so that the second front bar and the second rear bar are simultaneously folded or unfolded.

7. The parking robot of claim 6, wherein the caster unit comprises:
an annular bearing configured such that an inner race rotates relative to an outer race;
an annular bearing casing to which the bearing is fixedly coupled so that the outer race is supported on an inner peripheral surface thereof;
a bearing upper cover coupled to the inner race and rotatably coupled to the inner peripheral surface of the bearing casing; and
a bearing lower cover fastened to a lower side of the bearing upper cover and having a caster wheel fastening portion to which the caster wheel is coupled to be rotatable about a caster wheel rotation shaft, and
wherein the bearing casing is fixed to a caster unit fastening hole provided between the second front bar rotation shaft and the second rear bar rotation shaft.

8. The parking robot of claim 7, wherein the caster wheel protrudes toward the ground surface from a top surface of the bearing upper cover through a bearing upper cover opening provided in the bearing upper cover and a bearing lower cover opening provided in the bearing lower cover.

9. The parking robot of claim 6, wherein the first front bar comprises:
a first front bar bracket to which the first front bar rotation shaft is coupled; and
a first front worm wheel inserted and fixed into the first front bar bracket,
wherein the first rear bar comprises:
a first rear bar bracket to which the first rear bar rotation shaft is coupled; and
a first rear worm wheel inserted and fixed into the first rear bar bracket,
wherein the first lifting module further comprises a first worm shaft having two opposite ends at which a first front worm gear, which engages with the first front worm wheel, and a first rear worm gear, which engages with the first rear worm wheel, are provided, the first worm shaft being installed on the first cover and configured to receive a rotational force from the first lifting motor,
wherein the second front bar comprises:
a second front bar bracket to which the second front bar rotation shaft is coupled; and
a second front worm wheel inserted and fixed into the second front bar bracket,
wherein the second rear bar comprises:
a second rear bar bracket to which the second rear bar rotation shaft is coupled; and
a second rear worm wheel inserted and fixed into the second rear bar bracket, and
wherein the second lifting module further comprises a second worm shaft having two opposite ends at which a second front worm gear, which engages with the second front worm wheel, and a second rear worm gear, which engages with the second rear worm wheel, are provided, the second worm shaft being installed on the second cover and configured to receive a rotational force from the second lifting motor.

10. The parking robot of claim 9, wherein the first lifting motor is disposed in parallel with the first worm shaft in the width direction of the parking robot and comprises a first lifting belt provided on the second drive module and connected to a first worm shaft pulley provided at an end of the first worm shaft protruding from the first cover toward the second drive module, and
wherein the second lifting motor is disposed in parallel with the second worm shaft in the width direction of the parking robot and comprises a second lifting belt provided on the second control module and connected to a second worm shaft pulley provided at an end of the second worm shaft protruding from the second cover toward the second control module.

11. The parking robot of claim 7, wherein the first front bar comprises:
a first front bar bent portion formed at a side of the first front bar bracket; and
a plurality of first front bar rollers provided from the first front bar bracket to one end side of the first front bar,
wherein the first rear bar comprises:
a first rear bar bent portion formed at a side of the first rear bar bracket; and
a plurality of first rear bar rollers provided from the first rear bar bracket to one end side of the first rear bar,
wherein the second front bar comprises:
A second front bar bent portion formed at a side of the second front bar bracket; and
a plurality of second front bar rollers provided from the second front bar bracket to one end side of the second front bar, and
wherein the second rear bar comprises:
a second rear bar bent portion formed at a side of the second rear bar bracket; and
a plurality of second rear bar rollers provided from the second rear bar bracket to one end side of the second rear bar.

12. A parking robot, which enters a front wheel side or a rear wheel side of a vehicle, raises the vehicle from a ground surface, and moves the vehicle to a designated parking space, the parking robot comprising:
a pair of first driving wheels provided at one side of a front side of the parking robot;
a pair of second driving wheels provided at one side of a rear side of the parking robot; and
a caster wheel provided at the other side of a central portion of the parking robot and configured to support the parking robot from a ground surface together with the first driving wheel and the second driving wheel.

13. The parking robot of claim 12, further comprising:
a first drive module comprising the first driving wheels;
a second drive module comprising the second driving wheels;
a first lifting module provided between the first drive module and the second drive module;
a first control module provided at the other side of the front side of the parking robot;
a second control module provided at the other side of the rear side of the parking robot;
a second lifting module provided between the first control module and the second control module and installed with a caster unit comprising the caster wheel;
a battery module provided between the first lifting module and the second lifting module and provided rearward of the first drive module and the first control module; and
a third control module provided between the first lifting module and the second lifting module and provided rearward of the battery module.

14. The parking robot of claim 13, wherein the first drive module comprises:
a first plate having a first through-hole;
a first ring coupled to the first plate and configured to be rotatable about a central axis of the first through-hole;
a first tilting body comprising a first tilting shaft and fastened to the first ring;
a first tilting shaft having two opposite ends at which the first driving wheels are rotatably coupled, the first tilting shaft being coupled to the first tilting shaft so that any one side thereof is inclined upward or downward with respect to the first tilting shaft; and
first drive motors respectively fixed to front and rear sides of the first tilting shaft by first drive motor brackets and configured to independently rotate the first driving wheels, and
wherein the second drive module comprises:
a second plate having a second through-hole;
a second ring coupled to the second plate and configured to be rotatable about a central axis of the second through-hole;
a first tilting body comprising a second tilting shaft and fastened to the second ring;
a second tilting shaft having two opposite ends at which the second driving wheels are rotatably coupled, the second tilting shaft being coupled to the second tilting shaft so that any one side thereof is inclined upward or downward with respect to the second tilting shaft; and
second drive motors respectively fixed to front and rear sides of the second tilting shaft by second drive motor brackets and configured to independently rotate the second driving wheels.

15. The parking robot of claim 14, wherein the first drive module further comprises a first steering sensor provided adjacent to the first through-hole and configured to detect a rotation angle of the first ring, and
wherein the second drive module further comprises a second steering sensor provided adjacent to the second through-hole and configured to detect a rotation angle of the second ring.

16. The parking robot of claim 13, wherein the first lifting module comprises:
a first cover comprising a first front bar rotation shaft provided at a front side of the parking robot, and a first rear bar rotation shaft provided at a rear side of the parking robot;
a first front bar configured to be folded toward the front side of the parking robot with respect to the first cover based on the first front bar rotation shaft or unfolded in a width direction of the parking robot;
a first rear bar configured to be folded toward the rear side of the parking robot with respect to the first cover based on the first rear bar rotation shaft or unfolded in the width direction of the parking robot; and
a first lifting motor configured to provide a rotational force so that the first front bar and the first rear bar are simultaneously folded or unfolded, and
wherein the second lifting module comprises:
a second cover comprising a second front bar rotation shaft provided at the front side of the parking robot, and a second rear bar rotation shaft provided at the rear side of the parking robot;
a second front bar configured to be folded toward the front side of the parking robot with respect to the second cover based on the second front bar rotation shaft or unfolded in the width direction of the parking robot;
a second rear bar configured to be folded toward the rear side of the parking robot with respect to the second cover based on the second rear bar rotation shaft or unfolded in the width direction of the parking robot; and
a second lifting motor configured to provide a rotational force so that the second front bar and the second rear bar are simultaneously folded or unfolded.

17. The parking robot of claim 16, wherein the first front bar comprises:
a first front bar bracket to which the first front bar rotation shaft is coupled; and
a first front worm wheel inserted and fixed into the first front bar bracket,
wherein the first rear bar comprises:
a first rear bar bracket to which the first rear bar rotation shaft is coupled; and
a first rear worm wheel inserted and fixed into the first rear bar bracket,
wherein the first lifting module further comprises a first worm shaft having two opposite ends at which a first front worm gear, which engages with the first front worm wheel, and a first rear worm gear, which engages with the first rear worm wheel, are provided, the first worm shaft being installed on the first cover and configured to receive a rotational force from the first lifting motor,
wherein the second front bar comprises:
a second front bar bracket to which the second front bar rotation shaft is coupled; and
a second front worm wheel inserted and fixed into the second front bar bracket,
wherein the second rear bar comprises:
a second rear bar bracket to which the second rear bar rotation shaft is coupled; and
a second rear worm wheel inserted and fixed into the second rear bar bracket, and
wherein the second lifting module further comprises a second worm shaft having two opposite ends at which a second front worm gear, which engages with the second front worm wheel, and a second rear worm gear, which engages with the second rear worm wheel, are provided, the second worm shaft being installed on the second cover and configured to receive a rotational force from the second lifting motor.

18. The parking robot of claim 17, wherein the first lifting motor comprises a first lifting belt provided on the second drive module and connected to a first worm shaft pulley provided at an end of the first worm shaft protruding from the first cover toward the second drive module, and the first lifting motor is disposed in parallel with the first worm shaft in which width direction of the parking robot, and
wherein the second lifting motor comprises a first lifting belt provided on the second drive module and connected to a first worm shaft pulley provided at an end of the first worm shaft protruding from the first cover toward the second drive module, and the second lifting motor is disposed in parallel with the second worm shaft in the width direction of the parking robot.

19. A method of operating a parking robot, the method comprising:
allowing two parking robots to enter a lower space of a vehicle; and
positioning and deploying the two parking robots at a front wheel side and a rear wheel side of the vehicle to raise the vehicle from a ground surface and then move the vehicle to a designated parking space,
wherein the parking robot comprises:
a first drive module comprising first driving wheels;
a second drive module comprising second driving wheels and provided rearward of the first drive module;
a first lifting module provided between the first drive module and the second drive module; and
a second lifting module provided at one side of the first lifting module and comprising a caster unit having a caster wheel supported from the ground surface together with the first driving wheels and the second driving wheels, and
wherein the first lifting module and the second lifting module are deployed to raise the front wheel or the rear wheel of the vehicle from the ground surface.

20. The method of claim 19, wherein the parking robots are moved to the front wheel side and the rear wheel side of the vehicle so that the first drive modules face each other through the lower space of the vehicle.
